(19) United States
(12) Patent Application Publication
(10) Pub. No.: US 2026/0111299 A1
(43) Pub. Date: Apr. 23, 2026

(54) Method and Apparatus for Processing Processor Information, Non-Transitory Readable Storage Medium, and Electronic Device

(71) Applicant: SUZHOU METABRAIN INTELLIGENT TECHNOLOGY CO., LTD., Suzhou, Jiangsu (CN)

(72) Inventors: Xiuqiang SUN, Suzhou, Jiangsu (CN); Shan CHENG, Suzhou, Jiangsu (CN); Bole LI, Suzhou, Jiangsu (CN); Daotong LI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/147,056

(22) PCT Filed: May 24, 2024
(86) PCT No.: PCT/CN2024/095305

§ 371 Date: Jul. 10, 2025

(30) Foreign Application Priority Data
Dec. 28, 2023 (CN) 202311839058.0

(51) Int. Cl. G06F 11/07

(52) U.S. Cl. CPC G06F 11/0772; G06F 11/0769; G06F 11/0775; G06F 11/079; G06F 11/0778

(57) ABSTRACT

Provided are a method and an apparatus for processing processor information, a non-transitory readable storage medium, and an electronic device. The method includes: reading, by a baseboard management controller on a target device, a register value of a specified register, wherein the specified register is a register configured to store, according to the register value, error information generated by a set of components in the specified processor; parsing, by the baseboard management controller, a read target register value according to a set of specified parameters to obtain a target parsed result; and recording the target parsed result into a system event log of the baseboard management controller in a case where it is determined, according to the target parsed result that at least one component in the specified processor has generated error information.

### CROSS-REFERENCE TO RELATED APPLICATIONS

The present disclosure is a National Stage Filing of the PCT International Application No. PCT/CN2024/095305 filed on May 24, 2024, which claims priority to Chinese Patent Application No. 202311839058.0, filed with the Chinese Patent Office on Dec. 28, 2023 and entitled “Method and Apparatus for Processing Processor Information, Storage Medium, and Electronic Device”, which is incorporated herein by reference in its entirety.

### TECHNICAL FIELD

The embodiments of the present disclosure relate to the field of computers, and in particular, to a method and an apparatus for processing processor information, a non-transitory readable storage medium, and an electronic device.

### BACKGROUND

A processor chip is a key chip inside a device such as a server, which includes a plurality of key components therein. When these components have an error, a serious error will be caused to the entire system of the device to which these components belong. Therefore, it is necessary to report the error information timely to an operating system of the device to which these components belong.

Currently, the operating system records the error information in particular files (for example, a dmesg file). However, the error information is typically represented in values in binary form. It is not possible to quickly and accurately locate the location information of the components having an error in the processor, and it is necessary to parse them one by one through relevant technical documentation for locating analysis. Such a method for processing processor information significantly reduces working efficiency, especially when faced with hundreds of thousands of devices, probabilistic error reporting issues will significantly reduce fault handling efficiency.

Hence, the method for processing processor information in the related art has the problem of low processor fault handling efficiency.

### SUMMARY

The embodiments of the present disclosure provide a method and an apparatus for processing processor information, a non-transitory readable storage medium, and an electronic device, so as to at least solve the problem that the method for processing processor information in the related art has low processor fault handling efficiency.

According to a first aspect of the embodiments of the present disclosure, provided is a method for processing processor information, comprising: reading, by a baseboard management controller on a target device, a register value of a specified register, wherein the specified register is located in a specified processor of the target device, and the specified register is a register configured to store, according to the register value, error information generated by a set of components in the specified processor; parsing, by the baseboard management controller, a read target register value according to a set of specified parameters to obtain a target parsed result, wherein the set of specified parameters are parameters used to perform error information parsing; and recording the target parsed result into a system event log of the baseboard management controller in a case where it is determined, according to the target parsing result, that at least one component in the specified processor has generated error information.

According to a second aspect of the embodiments of the present disclosure, provided is an apparatus for processing processor information, comprising: a read unit configured to read, by a baseboard management controller on a target device, a register value of a specified register, wherein the specified register is located in a specified processor of the target device, and the specified register is a register configured to store, according to the register value, error information generated by a set of components in the specified processor; a parsing unit configured to parse, by the baseboard management controller, a read target register value according to a set of specified parameters to obtain a target parsed result, wherein the set of specified parameters are parameters used to perform error information parsing; and a recording unit configured to record the target parsed result into a system event log of the baseboard management controller in a case where it is determined, according to the target parsed result, that at least one component in the specified processor has generated error information.

According to a third aspect of the embodiments of the present disclosure, a non-transitory readable storage medium is further provided. The non-transitory readable storage medium stores a computer program, wherein the computer program is configured to execute the steps in any one of the described method embodiments during running.

According to a fourth aspect of the embodiments of the present disclosure, further provided is an electronic device, comprising a memory and a processor, wherein the memory stores a computer program, and the processor is configured to run the computer program so as to execute the steps in any of the described method embodiments.

The present disclosure uses the method of parsing register values into corresponding character information. As register values recording error information generated by components in a processor are binary, it is not possible to quickly and accurately locate the location information of the faulty components in the processor. By parsing the binary values according to certain rules and converting the binary values into corresponding character information and recording, processor fault location information may be located efficiently and quickly. Therefore, the problem that the method for processing processor information in the related art has low processor fault handling efficiency may be solved, achieving the technical effect of increasing the processor fault handling efficiency.

### BRIEF DESCRIPTION OF THE DRAWINGS

FIG. 1 is a schematic diagram of a hardware environment of a method for processing processor information according to an embodiment of the present disclosure;

FIG. 2 is a schematic flowchart of a method for processing processor information according to an embodiment of the present disclosure;

FIG. 3 is a schematic diagram of a method for processing processor information according to an embodiment of the present disclosure;

FIG. 4 is a schematic diagram of another method for processing processor information according to an embodiment of the present disclosure;

FIG. 5 is a schematic diagram of still another method for processing processor information according to an embodiment of the present disclosure;

FIG. 6 is a schematic diagram of still another method for processing processor information according to an embodiment of the present disclosure;

FIG. 7 is a schematic diagram of still another method for processing processor information according to an embodiment of the present disclosure;

FIG. 8 is a schematic diagram of an apparatus for processing processor information according to an embodiment of the present disclosure.

### DETAILED DESCRIPTION OF THE EMBODIMENTS

The embodiments of the present disclosure will be described below in detail with reference to the drawings and in conjunction with the embodiments.

It should be noted that, terms such as “target” and “second” in the description and the claims of the present disclosure and the described drawings are used to distinguish similar objects, but are not necessarily used to describe a specific sequence or order.

Before the embodiments of the present disclosure are described in detail, nouns and terms involved in the embodiments of the present disclosure are described. The nouns and terms involved in the embodiments of the present disclosure are applicable to the following explanations.

BIOS: Basic Input Output System.

ARM: Advanced RISC Machine, advanced reduced instruction set computer processor, a processor architecture.

CPU: Central Processing Unit.

dmesg: kernel ring buffer message, a program used to detect and control kernel ring buffering, the program helping users learn system boot information.

OS: Operating System.

CPM: Cluster Processor Module.

MCU: Memory Controller Unit.

Mesh: a CPU internal bus.

CCIX: Cache Coherent Interconnect for Accelerators, high-speed cache coherent interconnect technology for accelerators, a CCIX bus being a data transmission mode based on an extended PCle architecture, utilizing a layered architecture, the transmission mode may greatly increase the data transmission speed.

2P ALI: 2P Ampere Link Interconnect.

GIC: Generic Interrupt Controller.

SMMU: System Memory Management Unit.

PCle AER: PCI Express Advanced Error Reporting.

PCle RC: PCI Express Root Complex.

OCM: On-Chip Memory.

SMpro: System Management Processor.

PMpro: Power Management Processor.

ARM Processor: standard Arm processor error types.

ATF: Arm Trusted Firmware.

SMpro Firmware: System Management Processor Firmware.

BERT: Boot Error Record Table.

I2C: Inter-Integrated Circuit, a two-wire serial bus.

SCP: System Control Processor.

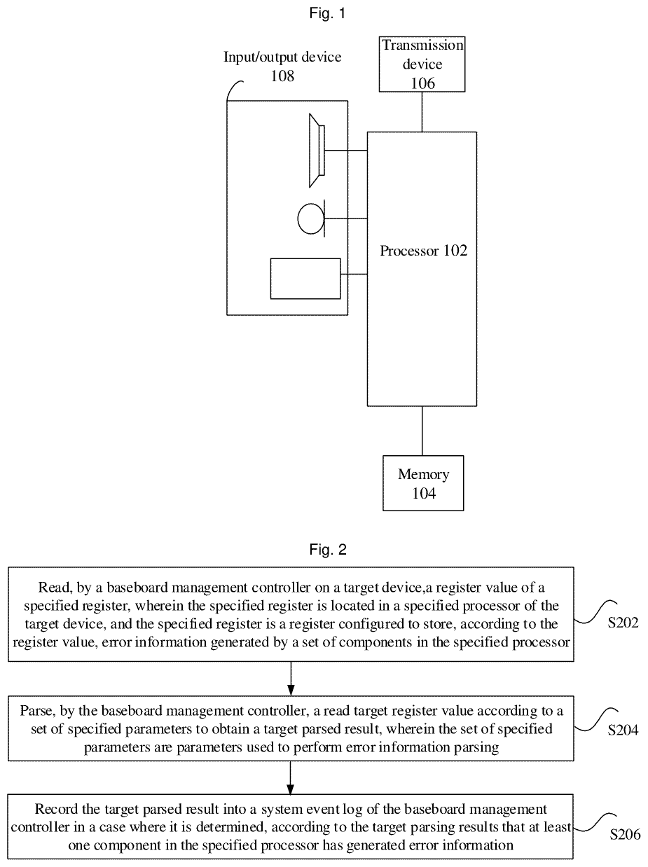

The method embodiments provided in the embodiments of the present disclosure may be executed in a server device or a similar computing apparatus. Taking running on a server device as an example, FIG. 1 is a hardware structural block diagram of a server device of a method for processing processor information according to an embodiment of the present disclosure. As shown in FIG. 1, a server device may include one or more (only one is shown in FIG. 1) processors 102 (the processors 102 may include but are not limited to processing devices such as a microprocessor (MCU) or a programmable logic device (FPGA)) and a memory 104 configured to store data, wherein the server device may further include a transmission device 106 and an input/output device 108 for a communication function. A person of ordinary skill in the art may understand that the structure shown in FIG. 1 is merely exemplary, which does not limit the structure of the described server device. For example, the server device may also includes components more or less than that shown in FIG. 1, or have a configuration different from that shown in FIG. 1.

The memory 104 may be configured to store a computer program, for example, a software program and a module of application software, such as a computer program corresponding to the method for processing processor information in the embodiments of the present disclosure. The processor 102 runs the computer program stored in the memory 104, so as to execute various function applications and data processing, that is, to implement the described method. The memory 104 may include a high-speed random access memory, and may also include a non-volatile memory, such as one or more magnetic storage apparatuses, flash memory, or other non-transitory solid-state memory. In some examples, the memory 104 includes a memory that is remotely located with respect to the processor 102, and such remote memory may be connected to a server device over a network. Examples of the described network include, but are not limited to, the Internet, intranets, local area networks, mobile communication networks, and combinations thereof.

The transmission device 106 is configured to receive or transmit data via a network. The described examples of the network may include a wireless network provided by a communication provider of the server device. In an example, the transmission device 106 may include a Network Interface Controller (NIC) that may be coupled to other network devices via a base station to communicate with the Internet. In an example, the transmission device 106 may be a Radio Frequency (RF) module configured to wirelessly communicate with the Internet.

This embodiment provides a method for processing processor information. FIG. 2 is a schematic flowchart of a method for processing processor information according to an embodiment of the present disclosure. As shown in FIG. 2, the flow includes the following steps:

Step S202: reading, by a baseboard management controller on a target device, a register value of a specified register, wherein the specified register is located in a specified processor of the target device, and the specified register is a register configured to store, according to the register value, error information generated by a set of components in the specified processor.

The method for processing processor information in this embodiment may be applied to a scenario of determining location information of components that generate error information in a processor. For example, in this embodiment, the processor may be an Advanced RISC Machines (ARM, advanced reduced instruction set computer processor, a processor architecture) architecture processor (also named an ARM processor). The ARM architecture processor includes a plurality of components, for example, core critical components including a memory bus device, a PCI link device, an ARM chip, an SMpro management component, a PMpro management component, a Mesh bus, an OCM device, a CCIX bus, and a GIC interrupt error. These components will inevitably cause serious or fatal errors to the entire system of the ARM server once the errors occur. Therefore, the error information must be timely reported to an operating system, and the operating system records the error information in the dmesg file. However, the error information is represented in value in binary form. It is not possible to quickly and accurately locate the location information of the components of the ARM processor, and it is necessary to parse them one by one through relevant technical documentation for locating analysis, which significantly reduces working efficiency.

In order to solve at least some of the described problems, in this embodiment, error register values of the processor are parsed according to certain rules, to convert the register value into corresponding character information and record the corresponding character information, for facilitating quick parsing and locating to locate processor fault location information efficiently and quickly. Taking the processor being an ARM processor as an example, BMC firmware quickly parses the errors generated in an ARM server system and records the errors into a System Event Log (SEL) to help subsequent research and development personnel and operation and maintenance personnel to quickly locate problems, and clearly identify the components which cause the problems and location information, making the process convenient and efficient, reducing the research and development resources used by the research and development personnel to analyze the faulty devices one by one, thereby increasing working efficiency.

In this embodiment, the processor is a core computing and control unit of the target device, and the register is an important component of the processor to store temporary data and instructions. Herein, the target device may be an ARM server, and the specified processor may be an ARM processor. In the case where the specified register is a register used to store, according to the register value, error information generated by a set of components in the specified processor, the register value of the specified registers may be read by the baseboard management controller (BMC) on the target device, and the register value may be represented in binary form.

Step S204: parsing, by the baseboard management controller, a read target register value according to a set of specified parameters to obtain a target parsed result, wherein the set of specified parameters are parameters configured to perform error information parsing.

In order to improve the readability of the processor error information, the binary register values read by the BMC may be converted into corresponding character information. In this embodiment, the read target register value may be parsed by the BMC according to a set of specified parameters, the target register value may be a binary value for representing error information generated by a set of components in the specified processor, and different values correspond to different error types and error information.

For example, in this embodiment, the error information generated by a set of components in the ARM processor includes, but is not limited to, error information of the internal bus and components of the ARM architecture, such as Mesh bus error, SMpro error information, PMpro error information, GIC interrupt error, SMMU error information, CPM error information, and OCM error information.

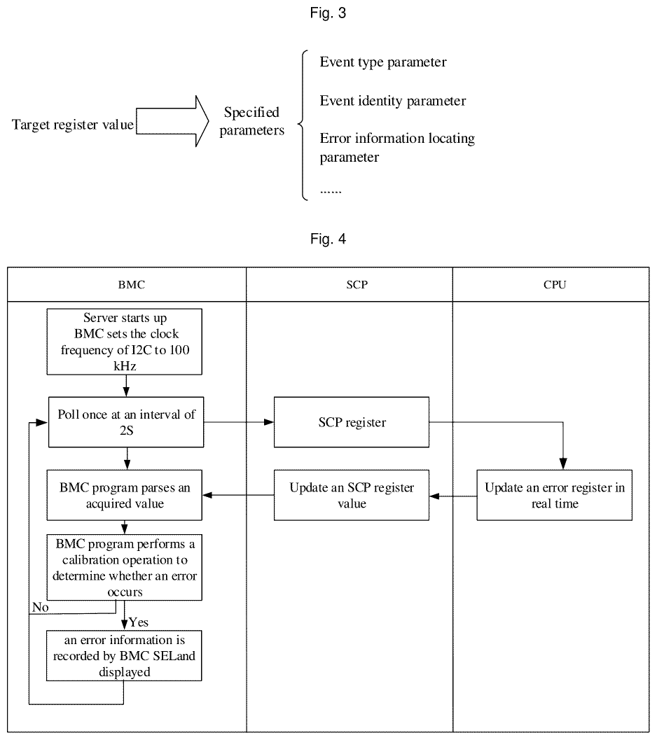

A set of specified parameters are parameters used to perform error information parsing, such that the BMC performs judgement and classification on the register value according to different error types and error information corresponding to different values. In one exemplary embodiment, in view of FIG. 3, the specified parameter may include but are not limited to an event type parameter, an event identity parameter, an error information locating parameter, and the like, and the parameter values of the specified parameter may be character information corresponding to the binary register values.

Step S206: recording the target parsed result into a system event log of the baseboard management controller in a case where it is determined, according to the target parsed result, that at least one component in the specified processor has generated error information.

An SEL is a log typically recording events and errors that occur in the system, including hardware fault, system crash, error messages, etc. Similar to the foregoing embodiments, the target parsed result may be character information corresponding to error information generated by a set of components in the specified processor. Upon determining from the target parsed result that at least one component in the specified processor has generated error information, the parsed error information character string may be recorded into the SEL of the BMC.

In the described steps, the register value of the specified register are read by the baseboard management controller on the target device, wherein the specified register is located in the specified processor of the target device, and the specified register is a register configured to store, according to the register value, error information generated by a set of components in the specified processor; the read target register value are parsed by the baseboard management controller according to a set of specified parameters to obtain target parsed result, wherein the set of specified parameters are parameters used to perform error information parsing; and the target parsed result are recorded into a system event log of the baseboard management controller in a case where it is determined, according to the target parsed result, that at least one component in the specified processor has generated error information, solving the problem that the method for processing processor information in the related art has low processor fault handling efficiency, and increasing the processor fault handling efficiency.

In an exemplary embodiment, parsing, by the baseboard management controller, a read target register value according to a set of specified parameters to obtain a target parsed result includes:
parsing, by the baseboard management controller, the read target register value by using a preset parsing tool according to the set of specified parameters to obtain the target parsed result, wherein the preset parsing tool is a parsing tool matching a data structure used by the specified register to perform data storage.

At present, the error information of the ARM processor may be recorded in a dmesg file in conventional systems, but this needs to log in the system and use a parsing tool to view and parse, which consumes time and labor. The BMC on intel platforms acquires the register value in a Central Processing Unit (CPU) via a certain bus, and then parses the acquired values via an out-of-band tool to acquire fault information of the CPU. This method is similar to fault information parsing in an ARM system, and is time-consuming.

In order to solve at least some of the described technical problems, the BMC in an ARM processor architecture may include a parsing tool therein to form a BMC code program (also named an BMC program, or BMC program code), and synchronously parse, by means of the BMC code program, values of the specified register acquired via an I2C and record same in an SEL log of the BMC, helping research and development and maintenance personnel to quickly locate fault problems.

For example, the one-to-one correspondence table for the parsing tool is as shown in Table 1:

TABLE 1

| COMPONENT | TYPE | | | INSTANCE |
|---|---|---|---|---|
| (ERROR GROUP) | [7:0] | SUBCOMPONENT | SUBTYPE | [13:0] |
| CPM | 0 | Snoop-Logic | 0 | CPM* |
| | | Armv8 Core 0 | 1 | CPM* |
| | | Armv8 Core 1 | 2 | CPM* |
| MCU | 10 | ERR1 | 1 | MCU* |
| | | ERR2 | 2 | MCU* |
| | | ERR3 | 3 | MCU* |
| | | ERR4 | 4 | MCU* |
| | | ERR5 | 5 | MCU* |
| | | ERR6 | 6 | MCU* |
| | | Link Error | 7 | MCU* |
| Mesh | 2 | Cross Point | 0 | N/A |
| | | Home Node(1O) | 1 | N/A |
| | | Home Node | 2 | N/A |
| | | (Memory) | | |
| | | CCIX Node | 4 | N/A |
| 2P CCIX | 3 | N/A | 0 | 2P Link |
| GIC | 5 | ERROR0 | 0 | 0 |
| | | ERROR1 | 1 | 0 |
| | | ERROR2 | 2 | 0 |
| | | ERROR3 | 3 | 0 |
| | | ERROR4 | 4 | 0 |
| SMMU | | TCU | 100 | RC* |
| | | TBU0 | 0 | RC* |
| | | TBU1 | 1 | RC* |
| | | TBU2 | 2 | RC* |
| PC1E AER | 7 | RP | 0 | Segment Number |
| | | Device | 1 | Segment Number |
| PCIe RC | 8 | RCA HB Error | 0 | RC* |
| | | RCB HB Error | 1 | RC* |
| | | RASDP Error | 8 | RC* |
| OCM | 9 | Error0 | 0 | 0 |
| | | Error1 | 1 | 0 |
| | | Error2 | 2 | 0 |
| SMPro | 10 | Error0 | 0 | 0 |
| | | Error1 | 1 | 0 |
| | | MPA_ERR | 2 | 0 |
| PMPro | 11 | Error0 | 0 | 0 |
| | | Error1 | 1 | 0 |
| | | MPA_ERR | 2 | 0 |
| BERT | 0x3F or | Watchdog | 1 | 0 |
| | 0x7F | UEFI Fatal | 5 | 0 |

In this embodiment, the read register value are parsed by the parsing tool, thereby increasing the efficiency of parsing processor error information, and reducing labor costs.

In an exemplary embodiment, parsing, by the baseboard management controller, a read target register value according to a set of specified parameters to obtain a target parsed result includes:
parsing, by the baseboard management controller, a value of at least one byte corresponding to each specified parameter in the set of specified parameters in the target register value to obtain parsed results respectively corresponding to the each specified parameter, wherein the target parsed result comprises the parsed results respectively corresponding to the each specified parameter.

Values of different bytes in the target register value may correspond to different specified parameters in the set of specified parameters. The acquired binary register values may be parsed by the BMC code program. For example, in this embodiment, the BMC code program may perform one-to-one parsing of the data structure of the target register values according to system events, record numbers, and the fixed 48-byte payload structure values, obtaining character information corresponding to the values, and the parsed results respectively corresponding to the specified parameters may be character information corresponding to the register value.

In an exemplary embodiment, parsing, by the baseboard management controller, a value of at least one byte corresponding to each specified parameter in the set of specified parameters in the target register value to obtain parsed results respectively corresponding to the each specified parameter includes:
in a case where the set of specified parameters comprises an event type parameter, parsing, by the baseboard management controller, a value of a first specified byte in the target register value to obtain target event type information, wherein the first specified byte is at least one byte corresponding to the event type parameter, and the event type parameter is a parameter corresponding to an event type of a system event which occurs in the specified processor.

For example, in this embodiment, the BMC performs system event parsing on the acquired register values to determine which system event has occurred, and for confirming the system event, reference may be made to Table 2.

TABLE 2

| System Event Value | Corresponding System Event |
|---|---|
| (Value of First Specified Byte) | (Event Type) |
| 0x7 | Processor |
| 0x1 | Temperature |
| 0x2 | Voltage |
| 0xC | Memory |
| 0xF | System Firmwares |
| 0x12 | System Event |
| 0x13 | Critical Interrupt |
| 0x21 | Slot/Connector |
| 0xC0 | OEM PCIE AER PCIe |
| 0xCA | OEM SCP |
| 0xCB | OEM Host SP1 |
| Other | Unknown_IError |

In an exemplary embodiment, parsing, by the baseboard management controller, a value of at least one byte corresponding to each specified parameter in the set of specified parameters in the target register value to obtain parsed results respectively corresponding to the each specified parameter includes:
in a case where the set of specified parameters comprises an event Identity document (ID) parameter, parsing, by the baseboard management controller, a value of a second specified byte in the target register values to obtain a target event ID, wherein the second specified byte is at least one byte corresponding to a record number, a mapping relationship exists between the record number and the event ID parameter, and the event ID parameter is a parameter corresponding to an event ID corresponding to a system event which occurs in the specified processor.

For example, in this embodiment, the record number is parsed to confirm the corresponding event identity information, and reference may be made to Table 3.

TABLE 3

| Record Number | Corresponding Event Identity |
|---|---|
| (Value of Second Specified Byte) | (ID) |
| 139 | CE_CPU_IError |
| 140 | UE_CPU_IError |
| 141 | CE_SoC_IError |
| 142 | UE_SoC_IError |
| 143 | S0_RAS_IError |
| 144 | S1_RAS_IError |
| 147 | RAS_SM_IError |
| 148 | RAS_PM_IError |
| 151 | CE_Memory_IError |
| 168 | UE_Memory_IError |
| 191 | CE_PCIe_IError |
| 202 | UE_PCIe_IError |
| 226 | S0_SCP_Status |
| 227 | S1_SCP_Status |
| 181 | S0_VR_WarnFault |
| 184 | S0_VR_WarnFault |
| 180 | S0_VR_HOT |
| 183 | S1_VR_HOT |
| 160 | S0_DIMM_HOT |
| 164 | S1_DIMM_HOT |
| 162 | S0_Refresh_Rate |
| 163 | S1_Refresh_Rate |
| Other | Unknown_IError |

In an exemplary embodiment, parsing, by the baseboard management controller, a value of at least one byte corresponding to each specified parameter in the set of specified parameters in the target register value to obtain parsed results respectively corresponding to the each specified parameter includes:
in a case where the set of specified parameters comprises an error information locating parameter, parsing, by the baseboard management controller, a value of a third specified byte in the target register value to obtain target locating information, wherein the third specified byte is at least one byte corresponding to the error information locating parameter, and the error information locating parameter is a parameter configured to locate a source component of error information, an error location in the source component, and a type of the error information.

For example, in this embodiment, the value of the third specified byte may be a 48-byte payload structure value, and the BMC parses an acquired payload structure value of the specified register to obtain the target locating information. The error information locating parameter is a parameter configured to locate the source component of error information, the error location in the source component, and the type of the error information, for example, determine a component that generates the error information in a processor, a location in the component, and the type of the error.

In one exemplary embodiment, the register error values of the ARM architecture processor are a set of 48-byte value, wherein 4 bytes are configured to confirm source component information of the error, and the remaining 44 bytes are configured to locate the error component information. Because the ARM processor has a large number of cores and memory slots have uniqueness, precise information locating may be performed by parsing 3-4 bytes. The method for parsing subsequent 44 bytes is similar, and its effect is to refine the types and sources of the errors.

In one exemplary embodiment, the error information locating parameter comprises a set of sub-locating parameters, and the set of sub-locating parameters comprises an error type parameter, an error subtype parameter and an error location parameter, wherein the error type parameter is configured to record the source component of the error information, the error subtype parameter is configured to record a source subcomponent in the source component of the error information, and the error location parameter is configured to record an error location where the error information occurs;

in a case where the set of specified parameters comprises the error information locating parameter, the parsing, by the baseboard management controller, a value of a third specified byte in the target register value to obtain target locating information comprises:
in a case where the set of specified parameters comprises the error information locating parameter, sequentially parsing, by the baseboard management controller, a value of at least one byte corresponding to each sub-locating parameter in the set of sub-locating parameters in the third specified byte in the target register value to obtain parsed results respectively corresponding to the each sub-locating parameter, wherein the target locating information comprises the parsed results respectively corresponding to the each sub-locating parameter.

For example, in this embodiment, 4 bytes include 1 byte of error type, 1 byte of error subtype and 2 bytes of error location information type. The BMC program code parses the values of the processor error information generated in the SCP. Firstly, the first byte among the first four bytes is parsed, and then after parsing for the component is completed, the component error is parsed, that is, the second byte is parsed to determine the Subtype so as to more accurately locate internal error information of the component; after the second byte is parsed, the next two bytes are parsed to confirm component location information where the error originates from.

In one exemplary embodiment, the first byte among the 48-byte values is acquired, and the character string information of the processor component is recorded and displayed according to a value parsing correlation preset in the BMC program; the BMC program acquires and parses the second byte among the 48 bytes, records the value of the Subtype and displays the corresponding character string information; the third byte and the fourth byte among the 48 bytes are parsed, and the third byte and the fourth byte must be parsed together to accurately locate from which location information an error originates, for example, a memory uncorrectable error originates from slot 0 of channel 1 of CPUO, or a Snoop-Lgic error of a CPM originates from CPM1 module group of the CPU, and other information follows a similar pattern; the remaining 44 bytes among the 48 bytes will not be described and explained in detail here, and the BMC program check scheme and principle therefor are similar to those for the first four bytes, and its effect is to further locate the source of the error.

In an exemplary embodiment, parsing, by the baseboard management controller, a value of at least one byte corresponding to each specified parameter in the set of specified parameters in the target register value to obtain parsed results respectively corresponding to the each specified parameter comprises:
searching, by the baseboard management controller, for parsed tables respectively corresponding to the each specified parameter and parsed results respectively corresponding to the each specified parameter using the value of at least one byte corresponding to the each specified parameter in the target register value, wherein the parsed tables respectively corresponding to the each specified parameter is configured to record a correlation between a value corresponding to the each specified parameter stored in the specified register and a parameter value of the each specified parameter.

The register values may correspond to the parameter values of the specified parameters in a one-to-one manner by the parsed tables, that is, the parsed tables corresponding to each specified parameter is configured to record a correlation between a value corresponding to each specified parameter stored in the specified register and a parameter value of each specified parameter.

In this embodiment, the value of at least one byte corresponding to each specified parameter in the target register value is used by the baseboard management controller to search for the parsed tables corresponding to each specified parameter, and the parsed results corresponding to the each specified parameter.

For example, in this embodiment, the parsed tables corresponding to a specified parameter system event is as shown in Table 2, and the parsed tables corresponding to a specified parameter event ID parameter is as shown in Table 3.

In an exemplary embodiment, reading, by a baseboard management controller on a target device, a register value of a specified register includes:
reading, by the baseboard management controller, the register value of the specified register via an integrated circuit bus having a specified clock frequency. Here, the specified register may refer to an internal error register of the ARM processor.

In an exemplary embodiment, the specified register is in a specified component of the specified processor.

Before reading, by the baseboard management controller, the register value of the specified register via an integrated circuit bus having a specified clock frequency, the method further includes:
setting a frequency of the integrated circuit bus via which the baseboard management controller communicates with the specified component to the specified clock frequency during initialization of the baseboard management controller.

For example, in this embodiment, the internal error register of the ARM processor are registered in the SCP component, and by initializing the clock frequency of the I2C bus for communicating with the SCP to 100 kilohertz (kHz) by the BMC, the BMC may read a register information of the SCP via the I2C bus at the clock frequency of 100 KHz.

In an exemplary embodiment, reading, by a baseboard management controller on a target device, a register value of a specified register includes:
reading, by the baseboard management controller, the register value of the specified register in a timed polling manner. A polling mechanism may facilitate real-time tracking and locating to determine whether the target device (for example, a server) has a fault. For example, in this embodiment, a timed polling (reading SCP register once per 2 seconds(s)) mechanism may be used to poll the SCP register value.

In an exemplary embodiment, during the running of the specified processor, the method further includes:
updating, by the specified processor, the register value stored in the specified register in real time according to the error information generated by the set of components.

The specified processor may be a reduced instruction set computer processor, for example, the ARM processor. In the case where error information has been generated by a set of components in the ARM processor, the register value stored in the internal error register of the ARM processor may be updated in real time on the basis of the generated error information.

For example, in view of FIG. 4, a time sequence diagram of the method for processing processor information according to the present disclosure may be shown in FIG. 4. When a BMC is initialized, the clock frequency of the I2C bus for communicating with the SCP is set to 100 KHz; a timed 2s polling mechanism is configured to read register values of the SCP in the running phase after the server is started; the specified processor updates the register value stored in the error register in real time on the basis of error information generated by a set of components; the SCP register value is correspondingly updated; the acquired register value is parsed by the BMC code program; an error information parsing result is confirmed, recorded in an SEL log of the BMC and displayed; and if there is no error, no error information parsing result is recorded into the SEL log of the BMC and the SCP register value is polled continuously.

In an exemplary embodiment, the target register value and the target parsed result is recorded together into the system event log of the baseboard management controller, and the target parsed result is target character string information obtained by parsing the target register value. After recording the target parsed result into the system event log of the baseboard management controller, the method further includes:
in response to an acquired fault information display request, displaying, by a specified display end, the target register value and the target character string information recorded in the system event log of the baseboard management controller.

For example, in this embodiment, upon completion of the parsing of system events, record numbers, and the conventional parsing of 48 bytes, the described information combination is displayed in the SEL log of the BMC one by one according to the corresponding values and corresponding explanations, and if no error occurs, the BMC SEL log does not record any error information.

The following describes a method for processing processor information in an embodiment of the present disclosure with reference to an optional example.

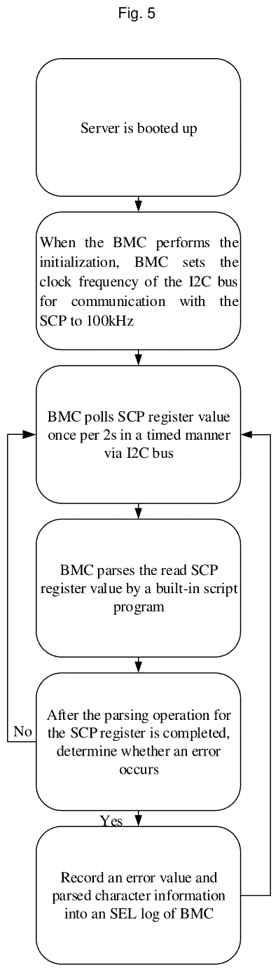

This optional example provides a method for a BMC to parse ARM processor error information. Optionally, in view of FIG. 5, a server is booted up; when the BMC is initialized, the clock frequency of the I2C bus for communicating with the SCP is set to 100 KHz; the BMC uses the timed 2s polling mechanism to read register value of the SCP via the I2C bus in the running phase after the server is started, and parses the acquired SCP register value by the BMC code program (a built-in script program); after the SCP register value is parsed, whether an error occurs is determined; if an error occurs, error information parsing results (register error value and parsed character information) are recorded into the SEL log of the BMC and displayed; and if there is no error, no error information parsing result is recorded into the SEL log of the BMC and the SCP register values are polled continuously. The BMC code program may perform one-to-one parsing of the data structure of the target register values according to system events, record numbers, and the fixed 48-byte payload structure values, and records and displays character information corresponding to the values. In this way, the error information of the ARM processor may be clearly and timely displayed on BMC web and recorded.

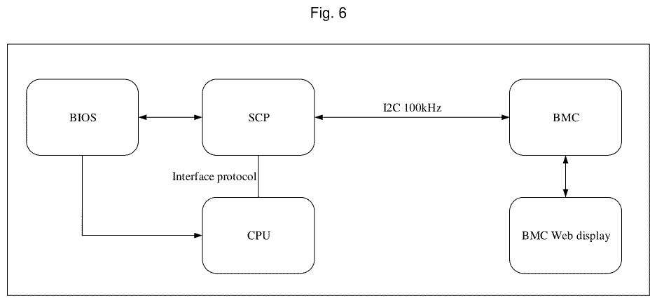

In view of FIG. 6, the physical architecture of a method for processing processor information according to the present disclosure may be as shown in FIG. 6. In view of FIG. 6, a BIOS is firmware of a computer system for initializing hardware and starting an operating system. A CPU is a central processing unit of a computer for executing programs and processing data. The BMC is an embedded management controller for monitoring and managing hardware of a computer system. The BIOS is responsible for starting a system and initializing hardware, the CPU executes computing and processing tasks, and the SCP and the BMC are used for managing and monitoring hardware and services of the system. For example, in this embodiment, the I2C clock may be set to 100 kHz by the BIOS, and the BMC may poll the SCP register of an ARM server via an I2C protocol.

The SCP register of the ARM server is read by the BMC firmware and the BMC via the I2C at a clock frequency of 100 kHz to determine and confirm error location information generated by the ARM server, quick checking is performed on the basis of a built-in correlation for error register in the BMC, and core location information is captured, displayed and recorded into an SEL log, allowing research and development personnel and operation and maintenance personnel to directly locate problems without error information collecting and parsing, thereby reducing labor costs.

Integrating a conventional method for the BMC reading the SCP register and polling to determine whether an error occurs and capturing the error register and parsing one by one according to the standard documentation into the BMC firmware, automatically parsing and displaying and recording the actual location information and component information where error information occurs in an SCP register increase the problem parsing efficiency by research and development personnel, and integrating the parsing method and steps into the management firmware BMC that reads the SCP reduces human involvement in problem parsing.

The BMC polls the SCP register of the ARM server via the I2C protocol, parses the read SCP register value, displays the parsed error information and type and location information, and records same into an SEL log of the BMC. Even if no serial port log and error log may be collected physically, since the BMC has completed parsing and located and displayed the error, research and development personnel and operation and maintenance personnel only need to download the SEL log to parse and locate the information of the component that causes the problems.

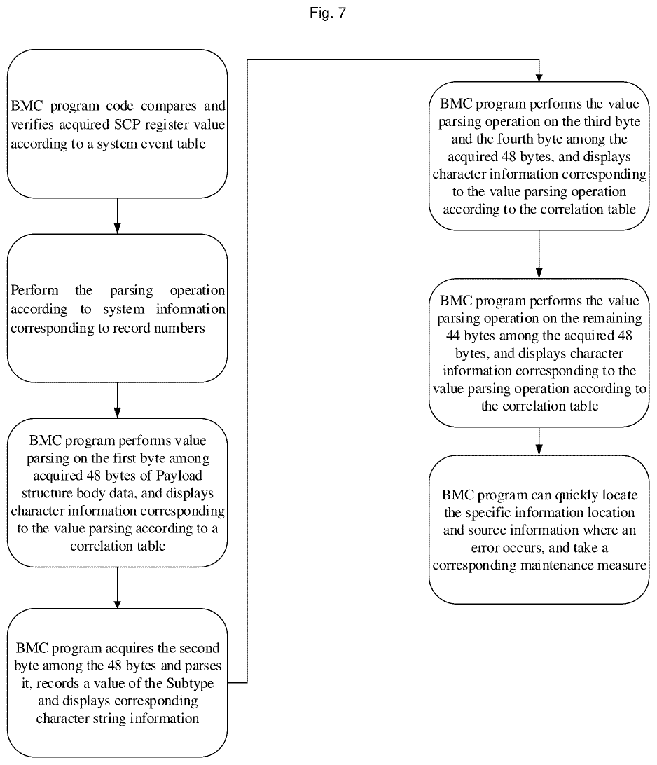

In one exemplary embodiment, the BMC parsing logic may be as shown in FIG. 7, including:
step 1: BMC program code compares and verifies acquired SCP register value according to a system event table;
step 2: parsing is performed according to system information corresponding to record number;
step 3: the BMC program performs value parsing on the first byte among acquired 48 bytes of Payload structure body data, and displays character information corresponding to the value parsing according to a correlation table;
step 4: the BMC program acquires the second byte among the 48 bytes and parses same, records a value of the Subtype and displays corresponding character string information;
step 5: the BMC program performs value parsing on the third byte and the fourth byte among the acquired 48 bytes, and displays character information corresponding to the value parsing according to the correlation table;
step 6: the BMC program performs value parsing on the remaining 44 bytes among the acquired 48 bytes, and displays character information corresponding to the value parsing according to the correlation table; and
step 7: the BMC program may quickly locate the information location and source information where an error occurs, and take a corresponding maintenance measure may be taken.

In this optional example, the SCP register value is polled in real time and parsed, and detailed fault location information and error types of the problems may be quickly located, making it convenient for maintenance personnel to quickly locate a fault problem and replace relevant core components when the ARM servers are deployed in batches in the data center, increasing the operation and maintenance efficiency and reducing labor costs of the operation and maintenance personnel, meanwhile satisfying the requirements for stability and reliability during system running.

It should be noted that, for brevity of description, the foregoing method embodiments are described as combination of a series of actions. However, persons skilled in the art should understand that the present disclosure is not limited to the described order of actions, because according to the present disclosure, some steps may be performed in another order or simultaneously. Secondly, persons skilled in the art should also know that the embodiments described therein are optional embodiments, and the involved actions and modules are not necessarily required in the present disclosure.

From the description of the described embodiments, a person skilled in the art may clearly understand that the methods according to the described embodiments may be implemented by software and a necessary universal hardware platform, and definitely may also be implemented by hardware. However, in many cases, the former is a preferred implementation. Based on such understanding, the technical solutions of the present disclosure essentially or the part contributing to the prior art may be embodied in the form of a software product. The computer software product is stored in a non-transitory readable storage medium (such as a ROM/RAM, a magnetic disk, or an optical disk), and includes several instructions for causing a terminal device (which may be a mobile phone, a computer, a server, or a network device) to execute the method described in the embodiment of the present disclosure.

This embodiment further provides an apparatus for processing processor information. The apparatus is configured to implement the described embodiments and optional implementations, and what has been described will not be elaborated. The term “module”, as used hereinafter, is a combination of software and/or hardware capable of realizing a predetermined function. Although the apparatus described in the following embodiment is preferably implemented by software, implementation by hardware or a combination of software and hardware is also possible and conceived.

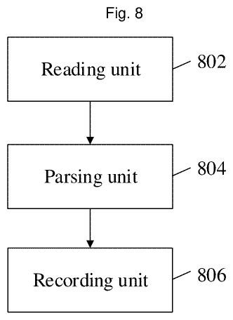

FIG. 8 is a structural block diagram of an apparatus for processing processor information according to an embodiment of the present disclosure. As shown in FIG. 8, the apparatus includes:
a reading unit 802 configured to read, by a baseboard management controller on a target device, a register value of a specified register, wherein the specified register is located in a specified processor of the target device, and the specified register is a register configured to store, according to the register value, error information generated by a set of components in the specified processor;
a parsing unit 804 configured to parse, by the baseboard management controller, a read target register value according to a set of specified parameters to obtain a target parsed result, wherein the set of specified parameters are parameters used to perform error information parsing; and
a recording unit 806 configured to record the target parsed result into a system event log of the baseboard management controller in a case where it is determined, according to the target parsed result, that at least one component in the specified processor has generated error information.

In this embodiment of the present disclosure, register values of a specified register are read by a baseboard management controller on a target device, wherein the specified register is located in a specified processor of the target device, and the specified register is a register used to store, by means of the register value, error information generated by a set of components in the specified processor; the read target register values are parsed by the baseboard management controller according to a set of specified parameters to obtain target parsing results, wherein the set of specified parameters are parameters used to perform error information parsing; and the target parsing results are recorded into a system event log of the baseboard management controller upon determining from the target parsing results that at least one component in the specified processor has generated error information, solving the problem that the method for processing processor information in the related art has low processor fault handling efficiency, and increasing the processor fault handling efficiency.

In one exemplary embodiment, the parsing unit includes:
a first parsing module configured to parse, by the baseboard management controller, the read target register value by using a preset parsing tool according to the set of specified parameters to obtain the target parsed result, wherein the preset parsing tool is a parsing tool matching a data structure used by the specified register to perform data storage.

In one exemplary embodiment, the parsing unit includes:
a second parsing module configured to parse, by the baseboard management controller, a value of at least one byte corresponding to each specified parameter in the set of specified parameters in the target register value to obtain parsed results respectively corresponding to the each specified parameter, wherein the target parsed result comprises the parsed results respectively corresponding to the each specified parameter.

In one exemplary embodiment, the second parsing module includes:
a first parsing submodule configured to, in a case where the set of specified parameters comprises an event type parameter, parsing, by the baseboard management controller, a value of a first specified byte in the target register value to obtain target event type information, wherein the first specified byte is at least one byte corresponding to the event type parameter, and the event type parameter is a parameter corresponding to an event type of a system event which occurs in the specified processor.

In one exemplary embodiment, the second parsing module includes:
a second parsing submodule configured to, in a case where the set of specified parameters includes an event ID parameter, parsing, by the baseboard management controller, a value of a second specified byte in the target register value to obtain a target event ID, wherein the second specified byte is at least one byte corresponding to a record number, a mapping relationship exists between the record number and the event ID parameter, and the event ID parameter is a parameter corresponding to an event ID corresponding to a system event which occurs in the specified processor.

Optionally, the second parsing module includes:
a third parsing submodule configured to, in a case where the set of specified parameters includes an error information locating parameter, parsing, by the baseboard management controller, a value of a third specified byte in the target register value to obtain target locating information, wherein the third specified byte is at least one byte corresponding to the error information locating parameter, and the error information locating parameter is a parameter configured to locate a source component of error information, an error location in the source component, and a type of the error information.

Optionally, the error information locating parameter includes a set of sub-locating parameters, and the set of sub-locating parameters includes an error type parameter, an error subtype parameter and an error location parameter, wherein the error type parameter is configured to record the source component of the error information, the error subtype parameter is configured to record a source subcomponent in the source component of the error information, and the error location parameter is configured to record an error location where the error information occurs.

The third parsing submodule comprises:
a parsing subunit configured to, in a case where the set of specified parameters comprises the error information locating parameter, sequentially parsing, by the baseboard management controller, a value of at least one byte corresponding to each sub-locating parameter in the set of sub-locating parameters in the third specified byte in the target register value to obtain parsed results respectively corresponding to the each sub-locating parameter, wherein the target locating information comprises the parsed results respectively corresponding to the each sub-locating parameter.

Optionally, the second parsing module includes:
a searching sub-module configured to search, by the baseboard management controller, for parsed tables respectively corresponding to the each specified parameter and parsed results respectively corresponding to the each specified parameter using the value of at least one byte corresponding to the each specified parameter in the target register value, wherein the parsed tables respectively corresponding to the each specified parameter is configured to record a correlation between a value corresponding to the each specified parameter stored in the specified register and a parameter value of the each specified parameter.

In one exemplary embodiment, the reading unit comprises:
a first reading module configured to read, by the baseboard management controller, the register value of the specified register via an integrated circuit bus having a specified clock frequency.

In one exemplary embodiment, the specified register is in a specified component of the specified processor.

The apparatus further includes:
a setting unit configured to set a frequency of the integrated circuit bus via which the baseboard management controller communicates with the specified component to the specified clock frequency during initialization of the baseboard management controller before reading, by the baseboard management controller, the register value of the specified register via the integrated circuit bus having a specified clock frequency.

In one exemplary embodiment, the reading unit includes:
a second reading module configured to read, by the baseboard management controller, the register value of the specified register in a timed polling manner.

In one exemplary embodiment, during running of the specified processor, the apparatus further includes:
an execution unit configured to update, by the specified processor, the register value stored in the specified register in real time according to the error information generated by the set of components.

In one exemplary embodiment, the target register value and the target parsed result are recorded together into the system event log of the baseboard management controller, and the target parsed result is target character string information obtained by parsing the target register value.

The apparatus further includes:
a display unit configured to, after recording the target parsed result into the system event log of the baseboard management controller, in response to an acquired fault information display request, display, by a specified display end, the target register value and the target character string information recorded in the system event log of the baseboard management controller.

Alternatively, the specified register is in a system control processor component of the specified processor, and the specified processor is a reduced instruction set computer processor.

The embodiments of the present disclosure further provide a non-transitory readable storage medium. The non-transitory readable storage medium stores a computer program, wherein the computer program is configured to execute the steps in any one of the described method embodiments during running.

In an exemplary embodiment, the non-transitory readable storage medium may include, but is not limited to, any medium that may store a computer program, such as a USB flash disk, a Read-Only Memory (ROM), a Random Access Memory (RAM), a removable hard disk, a magnetic disk, or an optical disk.

The embodiments of the present disclosure further provide an electronic device, comprising a memory and a processor, wherein the memory stores a computer program, and the processor is configured to run the computer program so as to execute the steps in any of the described method embodiments.

In an exemplary embodiment, the electronic device may further include a transmission device and an input/output device, wherein the transmission device is connected to the processor, and the input/output device is connected to the processor.

For optional examples in this embodiment, reference may be made to the examples described in the described embodiments and exemplary implementations, and details are not repeatedly described in this embodiment.

Obviously, those skilled in the art should understand that various modules or various steps of the present disclosure may be implemented by a universal computing apparatus, and the various modules or steps may be integrated on a single computing apparatus or distributed over a network formed by a plurality of computing apparatuses, and may be implemented by program codes executable by the computing apparatus, so that the modules or steps may be stored in a storage apparatus and executed by the computing apparatus, and the shown or described steps may be executed in sequences different from those described here in some cases, or the various modules or steps may be implemented by manufacturing the modules or steps into various integrated circuit modules respectively, or manufacturing multiple modules or steps among the various modules or steps into a single integrated circuit module. Thus, the present disclosure is not limited to any particular combination of hardware and software.

The foregoing descriptions are merely optional embodiments of the present disclosure, and are not intended to limit the present disclosure. For those skilled in the art, the present disclosure may have various modifications and variations. Any modifications, equivalent replacements, improvements and the like made within the principle of the present disclosure shall belong to the scope of protection of the present disclosure.

1. A method for processing processor information, comprising:
reading, by a baseboard management controller on a target device, a register value of a specified register, wherein the specified register is located in a specified processor of the target device, and the specified register is a register configured to store, according to the register value, error information generated by a set of components in the specified processor;
parsing, by the baseboard management controller, a read target register value according to a set of specified parameters to obtain a target parsed result, wherein the set of specified parameters are parameters used to perform error information parsing; and
recording the target parsed result into a system event log of the baseboard management controller in a case where it is determined, according to the target parsed result, that at least one component in the specified processor has generated error information;
wherein the reading, by a baseboard management controller on a target device, a register value of a specified register comprises: reading, by the baseboard management controller, the register value of the specified register via an integrated circuit bus having a specified clock frequency.

2. The method according to claim 1, wherein the parsing, by the baseboard management controller, a read target register value according to a set of specified parameters to obtain a target parsed result comprises:
parsing, by the baseboard management controller, the read target register value by using a preset parsing tool according to the set of specified parameters to obtain the target parsed result, wherein the preset parsing tool is a parsing tool matching a data structure used by the specified register to perform data storage.

3. The method according to claim 1, wherein the parsing, by the baseboard management controller, a read target register value according to a set of specified parameters to obtain a target parsed result comprises:
parsing, by the baseboard management controller, a value of at least one byte corresponding to each specified parameter in the set of specified parameters in the target register value to obtain parsed results respectively corresponding to the each specified parameter, wherein the target parsed result comprises the parsed results respectively corresponding to the each specified parameter.

4. The method according to claim 3, wherein the parsing, by the baseboard management controller, a value of at least one byte corresponding to each specified parameter in the set of specified parameters in the target register value to obtain parsed results respectively corresponding to the each specified parameter comprises:
in a case where the set of specified parameters comprises an event type parameter, parsing, by the baseboard management controller, a value of a first specified byte in the target register value to obtain target event type information, wherein the first specified byte is at least one byte corresponding to the event type parameter, and the event type parameter is a parameter corresponding to an event type of a system event which occurs in the specified processor.

5. The method according to claim 3, wherein the parsing, by the baseboard management controller, a value of at least one byte corresponding to each specified parameter in the set of specified parameters in the target register value to obtain parsed results respectively corresponding to the each specified parameter comprises:
in a case where the set of specified parameters comprises an event ID parameter, parsing, by the baseboard management controller, a value of a second specified byte in the target register values to obtain a target event ID, wherein the second specified byte is at least one byte corresponding to a record number, a mapping relationship exists between the record number and the event ID parameter, and the event ID parameter is a parameter corresponding to an event ID corresponding to a system event which occurs in the specified processor.

6. The method according to claim 3, wherein the parsing, by the baseboard management controller, a value of at least one byte corresponding to each specified parameter in the set of specified parameters in the target register value to obtain parsed results respectively corresponding to the each specified parameter comprises:
in a case where the set of specified parameters comprises an error information locating parameter, parsing, by the baseboard management controller, a value of a third specified byte in the target register value to obtain target locating information, wherein the third specified byte is at least one byte corresponding to the error information locating parameter, and the error information locating parameter is a parameter configured to locate a source component of error information, an error location in the source component, and a type of the error information.

7. The method according to claim 6, wherein the error information locating parameter comprises a set of sub-locating parameters, and the set of sub-locating parameters comprises an error type parameter, an error subtype parameter and an error location parameter, wherein the error type parameter is configured to record the source component of the error information, the error subtype parameter is configured to record a source subcomponent in the source component of the error information, and the error location parameter is configured to record an error location where the error information occurs;
in a case where the set of specified parameters comprises the error information locating parameter, the parsing, by the baseboard management controller, a value of a third specified byte in the target register value to obtain target locating information comprises:
in a case where the set of specified parameters comprises the error information locating parameter, sequentially parsing, by the baseboard management controller, a value of at least one byte corresponding to each sub-locating parameter in the set of sub-locating parameters in the third specified byte in the target register value to obtain parsed results respectively corresponding to the each sub-locating parameter, wherein the target locating information comprises the parsed results respectively corresponding to the each sub-locating parameter.

8. The method according to claim 3, wherein the parsing, by the baseboard management controller, a value of at least one byte corresponding to each specified parameter in the set of specified parameters in the target register value to obtain parsed results respectively corresponding to the each specified parameter comprises:
searching, by the baseboard management controller, for parsed tables respectively corresponding to the each specified parameter and parsed results respectively corresponding to the each specified parameter using the value of at least one byte corresponding to the each specified parameter in the target register value, wherein the parsed tables respectively corresponding to the each specified parameter is configured to record a correlation between a value corresponding to the each specified parameter stored in the specified register and a parameter value of the each specified parameter.

9. (canceled)

10. The method according to claim 1, wherein the specified register is in a specified component of the specified processor; before reading, by the baseboard management controller, the register value of the specified register via an integrated circuit bus having a specified clock frequency, the method further comprises:
setting a frequency of the integrated circuit bus via which the baseboard management controller communicates with the specified component to the specified clock frequency during initialization of the baseboard management controller.

11. The method according to claim 1, wherein the reading, by a baseboard management controller on a target device, a register value of a specified register comprises:
reading, by the baseboard management controller, the register value of the specified register in a timed polling manner.

12. The method according to claim 1, wherein during the running of the specified processor, the method further comprises:
updating, by the specified processor, the register value stored in the specified register in real time according to the error information generated by the set of components.

13. The method according to claim 1, wherein the target register value and the target parsed result are recorded together into the system event log of the baseboard management controller, and the target parsed result is target character string information obtained by parsing the target register value;
after recording the target parsed result into the system event log of the baseboard management controller, the method further comprises:
in response to an acquired fault information display request, displaying, by a specified display end, the target register value and the target character string information recorded in the system event log of the baseboard management controller.

14. The method according to claim 1, wherein the specified register is in a system control processor component of the specified processor, and the specified processor is a reduced instruction set computer processor.

15. The method according to claim 3, wherein values of different fields in the target register value correspond to different specified parameters in the set of specified parameters.

16. The method according to claim 6, wherein parsing, by the baseboard management controller, a value of a third specified byte in the target register value to obtain target locating information comprises:
parsing, by the baseboard management controller, an acquired payload structure value of the specified register to obtain the target locating information.

17. The method according to claim 6, wherein before parsing, by the baseboard management controller, a value of a third specified byte in the target register value, the method further comprises:
acquiring a 48-byte payload structure value as the value of the third specified byte.

18-20. (canceled)

21. The method according to claim 1, wherein the target register value binary values for representing error information generated by a set of components in the specified processor, and different values correspond to different error types and error information.

22. The method according to claim 1, wherein a parameter value of the specified parameters character information corresponding to the binary register value.

23. The method according to claim 1, wherein the baseboard management controller (BMC) in an Advanced RISC Machine (ARM) processor architecture includes a parsing tool therein to form a BMC code program, and synchronously parse, by means of the BMC code program, values of the specified register acquired via an Inter-Integrated Circuit (I2C) and record same in an System Event Log (SEL) log of the baseboard management controller.

24. The method according to claim 23, wherein Values of different bytes in the target register value correspond to different specified parameters in the set of specified parameters and the acquired binary register values are parsed by the BMC code program.
